(19) United States
(12) Patent Application Publication
(10) Pub. No.: US 2018/0167730 A1
(43) Pub. Date: Jun. 14, 2018

(54) MICROELECTROMECHANICAL SYSTEMS (MEMS) MICROPHONE FEEDBACK FILTERING

(71) Applicant: INVENSENSE, INC., San Jose, CA (US)

(72) Inventor: Jeremy Michael Parker, Chelmsford, MA (US)

(21) Appl. No.: 15/375,886

(22) Filed: Dec. 12, 2016

(51) Int. Cl. H04R 3/02; H04R 1/04; H04R 19/00; H04R 19/04

(52) U.S. Cl. CPC H04R 3/02; H04R 1/04; H04R 2410/03; H04R 19/04; H04R 2201/003; H04R 19/005

(57) ABSTRACT

Feedback filtering for microelectromechanical systems (MEMS) sensors is described. An exemplary MEMS sensor system or apparatus can comprise a MEMS sensor and an associated integrated circuit (IC) or portions there of that facilitate shaping MEMS sensor frequency response by controlling or filtering a feedback signal. In addition, various methods of controlling or filtering a feedback signal for MEMS sensor are described.

### TECHNICAL FIELD

The subject disclosure relates to microelectromechanical systems (MEMS) sensors and more particularly to feedback filtering for microelectromechanical systems (MEMS) microphones.

### BACKGROUND

Mobile devices are becoming increasingly lightweight and compact, while user demand for applications that are more complex, higher performance, and/or are more feature-rich drives sensor specification requirements in order to be able to meet the demand. For example, conventional mobile devices and systems such as mobile phones use one or more acoustic sensors (e.g., micro-electromechanical systems (MEMS) sensor element such as a microphone, etc.) of a sensor system, which are specifically designed and/or configured for specific applications that dictate a particular set of sensor system specification requirements (e.g., frequency response, sound pressure level (SPL) handling, suppressed ultrasonic response, etc.). In other applications, for example, which employ ultrasonic transducers and associated sensor systems, such sensor systems are specifically designed and/or configured according to a different set of sensor system specification requirements (e.g., elevated ultrasonic response, etc.).

Moreover, as such MEMS sensors and sensor systems are pressed into an increasingly diverse array of operating environments, limitations of the original design sensor system specification requirements may become apparent or reveal opportunities for tailoring frequency response to the new operating environment. For instance, one specific application or operating environment might require one or more of a specific sensor system frequency response, a frequency-specific overload requirement, a SPL requirement, a signal to noise ratio (SNR) specification, etc., while another specific application or operating environment might require a different set of sensor system specification requirements. While conventional techniques for shaping MEMS sensor system frequency response can alleviate some drawbacks associated with MEMS sensor systems specifically designed and/or configured for specific applications and associated sensor system specification requirements, such conventional techniques may suffer from any of a combination of drawbacks to MEMS sensor system implementations including inflexibility, increased cost and/or complexity, poor relative performance, increased die and/or package footprint in terms of integrated circuit (IC) or application-specific integrated circuit (ASIC) die area and/or MEMS sensor package area, etc., as described above, and as further described herein.

It is thus desired to provide MEMS sensors systems and apparatuses that improve upon these and other deficiencies. The above-described deficiencies are merely intended to provide an overview of some of the problems of conventional implementations, and are not intended to be exhaustive. Other problems with conventional implementations and techniques, and corresponding benefits of the various aspects described herein, may become further apparent upon review of the following description.

### SUMMARY

The following presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented later.

In a non-limiting example, exemplary apparatuses are described that can comprise electrical circuitry configured to receive an electrical signal from a first portion of a microelectromechanical systems (MEMS) sensor and generate an output signal associated with the first portion of the MEMS sensor, in a non-limiting aspect. In further non-limiting aspects, exemplary apparatuses can comprise a feedback component configured to generate a feedback signal based on the output signal for a second portion of the MEMS sensor, and one or more filter components configured to filter the feedback signal for the second portion of the MEMS sensor. In still further non-limiting aspects, exemplary apparatuses can further comprise a filter control component configured to switch the one or more filter components between an on state and an off state or modify performance of the at least one filter component, wherein the feedback signal can be configured reduce sensitivity of the MEMS sensor, increase an acoustic overload point (AOP) associated with an exemplary MEMS sensor comprising a MEMS acoustic sensor or microphone, reduce a resonance peak associated with exemplary MEMS sensor, reduce generated noise associated with exemplary MEMS sensor, increase signal to noise ratio associated with exemplary MEMS sensor, and/or modify frequency response of the MEMS sensor.

Moreover, exemplary methods are described, which comprise receiving an electrical signal from a first portion of an exemplary MEMS sensor, generating an output signal associated with the first portion of the MEMS sensor, generating a feedback signal based on the output signal for a second portion of the MEMS sensor, and filtering the feedback signal for transmission to the second portion of the MEMS sensor, as further described herein.

These and other embodiments are described in more detail below.

### BRIEF DESCRIPTION OF THE DRAWINGS

Various non-limiting embodiments are further described with reference to the accompanying drawings, in which:

FIG. 1 depicts a functional block diagram of an exemplary microelectromechanical systems (MEMS) sensor system or apparatus suitable for incorporation of various non-limiting aspects of the subject disclosure;

FIG. 2 depicts a non-limiting cross sectional diagram of an exemplary MEMS sensor package, in which an application-specific integrated circuit (ASIC) chip associated with a MEMS acoustic sensor or microphone is disposed, and which is suitable for incorporation of further non-limiting aspects of the subject disclosure;

FIG. 3 depicts a non-limiting schematic diagram of an exemplary MEMS sensor system or apparatus depicting an exemplary feedback technique, according to further non-limiting aspects of the subject disclosure;

FIG. 4 depicts another non-limiting schematic diagram of an exemplary MEMS sensor system or apparatus depicting an exemplary feedback technique employing feedback filtering, according to non-limiting aspects as described herein;

FIG. 5 depicts a further non-limiting schematic diagram of a particular exemplary embodiment of a MEMS sensor system or apparatus that demonstrates an exemplary feedback technique employing feedback filtering, according to further non-limiting aspects as described herein;

FIG. 6 depicts simulated frequency response of exemplary MEMS sensor systems or apparatuses employing non-limiting aspects of feedback filtering techniques according to non-limiting embodiments as described herein;

FIG. 7 depicts simulated, normalized frequency responses of a lumped element model simulation of exemplary MEMS sensor systems or apparatuses employing non-limiting aspects of feedback filtering techniques used to simulate various filter types and filter frequencies versus no feedback and filtered feedback, according to further non-limiting aspects of the subject disclosure;

FIG. 8 depicts noise amplitude spectral densities according to simulated, normalized frequency responses of the lumped element model simulation of exemplary MEMS sensor systems or apparatuses described with reference to FIG. 7;

FIG. 9 depicts an exemplary flowchart of non-limiting methods associated with exemplary MEMS sensor systems or apparatuses employing feedback filtering, according to various non-limiting aspects of the disclosed subject matter; and

FIG. 10 illustrates a schematic diagram of an exemplary mobile device (e.g., a mobile handset) that can facilitate various non-limiting aspects of the subject disclosure in accordance with the embodiments described herein.

### DETAILED DESCRIPTION

### Overview

While a brief overview is provided, certain aspects of the subject disclosure are described or depicted herein for the purposes of illustration and not limitation. Thus, variations of the disclosed embodiments as suggested by the disclosed apparatuses, systems, and methodologies are intended to be encompassed within the scope of the subject matter disclosed herein. As a non-limiting example, while various embodiments are described herein in reference to an acoustic sensor or microphone comprising a micro-electromechanical systems (MEMS) sensor element (e.g., an acoustic sensor element, etc.) for the purposes of illustration, and not limitation, it can be understood that various embodiments as described herein can be employed in any kind of MEMS sensor system or apparatus or any other sensor system.

As described above, sensor systems are specifically designed and/or configured for specific applications that dictate a particular set of sensor system specification requirements (e.g., frequency response, sound pressure level (SPL) handling, suppressed ultrasonic response, etc.). In many cases, such design requirements dictate or restrict MEMS sensor device fabrication and/or implementation details or are dictated or restricted thereby. As a non-limiting example, damping can be a primary source of noise in MEMS acoustic sensor or microphones, where increased damping of the backplate to adjust microphone frequency response can result in increased noise and decreased signal to noise ratio (SNR). For instance, for resonant peak characteristics of MEMS acoustic sensor or microphones that have good sensitivity and high SNR (e.g., due to MEMS acoustic sensor or microphones structure having a low damping and a certain ratio of mass and compliance), it may be desirable for particular implementations to reduce such resonant peaks or shift them to other areas of the frequency range (e.g., beyond 20 kilohertz (kHz)), such that the frequency response is flatter in the audio band (e.g., 20 Hertz (Hz) to 20 kHz), without altering the fabrication of MEMS acoustic sensor or microphones and their physical structures that provide low damping and the certain ratio of mass and compliance. However, it can be further understood that reducing resonant peak height by increasing damping can cause too much degradation to device performance characteristics such as equivalent input noise (EIN) and SNR.

As a non-limiting example, resonant peaks at higher frequency than frequencies of interest and/or lower amplitude resonant peak leads to better SNR, whereas systems or device designers employing MEMS acoustic sensor or microphones generally prefer flatter frequency response up to 20 kHz, whereas some prefer elevated ultrasonic response, and whereas still others prefer suppressed ultrasonic response. As another non-limiting example, a manufacturer of hearing aids may desire MEMS acoustic sensor or microphone systems with better high-frequency high SPL handling to combat the effects of occupancy sensors (e.g., in the 25 kHz or 32-33 kHz range, where as other applications designers may desire handling of high-frequency high-SPL sources (or low-frequency, high-SPL sources) such as drums, which can cause MEMS acoustic sensor or microphones systems to overload, leading to audible artifacts. It can be understood that any reduction of a MEMS sensor's resonant peak will provide a benefit to signal to noise ratio as the integrated noise would go down.

As further described above, while conventional techniques for shaping MEMS sensor system frequency response can alleviate some drawbacks associated with MEMS sensor systems specifically designed and/or configured for specific applications and associated sensor system specification requirements, such conventional techniques may suffer from any of a combination of drawbacks to MEMS sensor system implementations including inflexibility, increased cost and/or complexity, poor relative performance, increased die and/or package footprint in terms of integrated circuit (IC) or application-specific integrated circuit (ASIC) die area and/or MEMS sensor package area, etc. For example, in conventional techniques of shaping frequency response of MEMS acoustic sensor or microphones, any type of equalization or filtering is done after MEMS acoustic sensor or microphones, whereas equalization or filtering is most commonly performed after the output of the microphone ASIC. In another non-limiting example of conventional techniques, placing a capacitor across the output to ground thereby forming a low-pass filter with the MEMS sensor output impedance can also reduce the MEMS sensor resonant peak, but it would do so at the expense of total harmonic distortion (THD), intermodulation distortion (IMD), output impedance, reduced acoustic overload point (AOP) at high frequencies, and so on, as further inherent drawbacks.

Various non-limiting embodiments of the disclosed subject matter can provide techniques for reducing or shifting such resident peaks, while providing additional benefits such as increasing the AOP, based in part on frequency, to facilitate providing sensor systems meeting a broad array of disparate sensor system specification requirements without necessitating underlying MEMS sensor device fabrication and/or other implementation details. In a non-limiting aspect, non-limiting embodiments of the disclosed subject matter can employ a filter in a feedback loop of a MEMS sensor (e.g., a MEMS acoustic sensor or microphone, etc.). In another non-limiting aspect, exemplary embodiments of the disclosed subject matter comprising a MEMS acoustic sensor or microphone can employ a filter in a feedback loop to a MEMS acoustic sensor or microphone backplate, which can facilitate imposing the filtered response on the MEMS acoustic sensor or microphone, without changes to the MEMS acoustic sensor or microphone (e.g., damping, etc.), that would otherwise be necessary to impart similar frequency response changes.

In another non-limiting aspect, exemplary embodiments can employ a filter in a feedback loop, comprising an inverted version of an output signal associated with a MEMS sensor (e.g., a MEMS acoustic sensor or microphone, etc.), which can be fed back to a portion of a MEMS sensor (e.g., a backplate of a MEMS acoustic sensor or microphone, etc.). In yet another non-limiting aspect, where a portion of a MEMS sensor (e.g., a backplate of a MEMS acoustic sensor or microphone, etc.) that normally has only a static direct current (DC) bias voltage applied, an exemplary feedback signal comprising the inverted signal can comprise a negative feedback signal, which can reduce the gain or sensitivity of the MEMS sensor (e.g., a MEMS acoustic sensor or microphone, etc.) as seen by an input stage (e.g., an input buffer) of an associated ASIC (e.g., 6 decibels (dB) lower than without feedback, while concurrently raise the AOP by 6 dB, as further described herein. That is, by applying a negative feedback signal to a portion of a MEMS sensor (e.g., a backplate of a MEMS acoustic sensor or microphone, etc.), various disclosed embodiments can make a MEMS sensor (e.g., a MEMS acoustic sensor or microphone, etc.) appear to be 6 dB less sensitive to an applied signal (e.g., an applied acoustic signal). As a non-limiting example, it can be understood that the point at which a MEMS acoustic sensor or microphone output begins to clip is largely controlled by when the ASIC input buffer diodes saturate, and, as a result, by applying feedback to a MEMS acoustic sensor or microphone, for example, resultant AOP can be improved by 6 dB, according to a further non-limiting aspect. In still another non-limiting aspect, various embodiments as described herein can comprise a feedback filter incorporated into an existing ASIC die for an ASIC associated with MEMS sensor (e.g., a MEMS acoustic sensor or microphone, etc.).

In addition, in a further non-limiting aspect of the disclosed subject matter, exemplary embodiments as described herein can facilitate shaping frequency response of an associated MEMS sensor (e.g., a MEMS acoustic sensor or microphone, etc.) without compromising device specifications like noise and SNR, which would result from physical fabrication and/or implementation changes to MEMS sensor (e.g., a MEMS acoustic sensor or microphone, etc.) that would otherwise be necessary (e.g., damping in the case of a MEMS acoustic sensor or microphone, etc.), to impart similar frequency response changes, and/or implicate other drawbacks of conventional methods of shaping frequency response, reducing or shifting such resident peaks, and so on, as further described herein. In yet another non-limiting aspect, exemplary embodiments as described herein can allow a transition from feedback to no feedback based on frequency. As described above, for the case of reducing a MEMS sensor resonant peak, exemplary embodiments can provide further improvements over conventional methods, such as employing a capacitor from a MEMS sensor output to ground in combination with high-output impedance (e.g., creating a low-pass filter), by allowing flexibility in determining cutoff or corner frequency associated with output impedance without impacting output impedance, by limiting or eliminating increases in THD and/or IMD at frequencies when the filter is active (e.g., in contrast to the low-pass filter with the output capacitor), by extending MEMS sensor AOP directly by the amount of attenuation (e.g., in contrast to the low-pass filter with the output capacitor), and by eliminating added MEMS sensor package cost, manufacturing complexity, and MEMS sensor package volume impact associated with the low-pass filter with the output capacitor (e.g., associated acoustic performance degradation in the case of a MEMS acoustic sensor or microphone, such as increased low-frequency corner and low-frequency noise, decreased sensitivity, etc. associated therewith).

In a non-limiting aspect of the disclosed subject matter, various exemplary embodiments can be employed in the context of a MEMS sensor comprising a MEMS acoustic sensor or microphone, as further described herein. However, as further detailed below, various exemplary implementations can be applied to other areas of MEMS sensor systems and apparatuses, without departing from the subject matter described herein.

### Exemplary Embodiments

Various aspects or features of the subject disclosure are described with reference to the drawings, wherein like reference numerals are used to refer to like elements throughout. In this specification, numerous specific details are set forth in order to provide a thorough understanding of the subject disclosure. It should be understood, however, that the certain aspects of disclosure may be practiced without these specific details, or with other methods, components, parameters, etc. In other instances, well-known structures and devices are shown in block diagram form to facilitate description and illustration of the various embodiments.

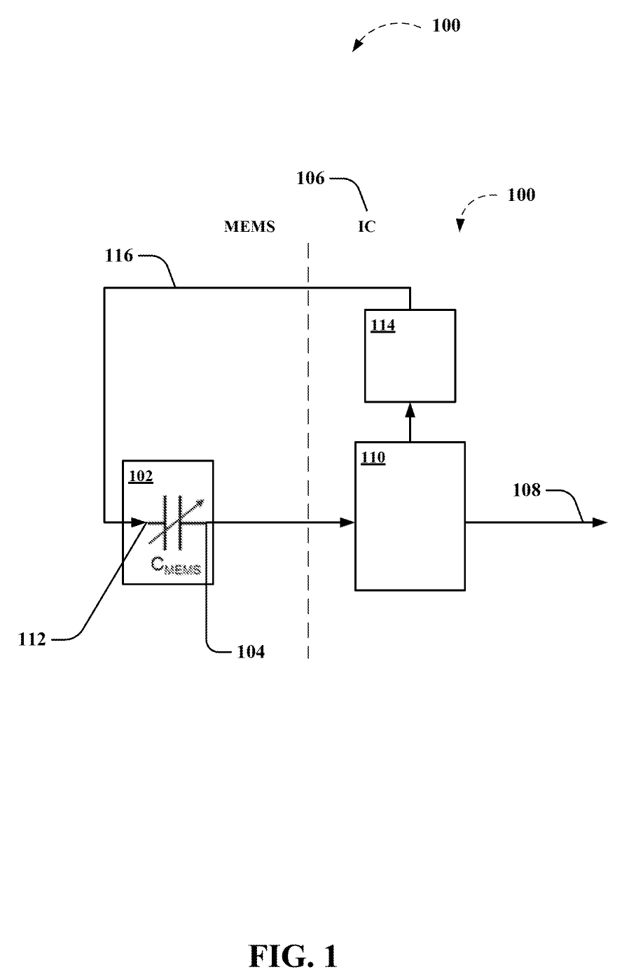

FIG. 1 depicts a functional block diagram of an exemplary MEMS sensor system or apparatus 100 suitable for incorporation of various non-limiting aspects of the subject disclosure. Various non-limiting embodiments of exemplary MEMS sensor system or apparatus 100 can comprise one or more of MEMS sensor 102 and electrical circuitry configured to receive an electrical signal from a first portion 104 of MEMS sensor 102. In a non-limiting aspect, exemplary electrical circuitry can comprise or be associated with an IC 106. In another non-limiting aspect, the electrical circuitry can be further configured to generate an output signal 108 associated with the first portion 104 of MEMS sensor 102.

Further non-limiting embodiments of exemplary MEMS sensor system or apparatus 100 can comprise one or more of exemplary feedback component 110 and one or more filter components 114. In further non-limiting aspects, exemplary IC 106 can comprise or be associated with one or more of exemplary feedback component 110 and one or more exemplary filter components 114. In addition, exemplary feedback component 110 can be configured to generate a feedback signal 116 based on output signal 108 for a second portion 112 of exemplary MEMS sensor 102, for example, as further described herein. In still further non-limiting aspects, exemplary one or more filter components 114 can be configured to filter the feedback signal 116 for second portion 112 of exemplary MEMS sensor 102.

In a non-limiting aspect of exemplary MEMS sensor system or apparatus 100, exemplary MEMS sensor 102 can comprise an exemplary MEMS acoustic sensor, an exemplary MEMS microphone sensor, an exemplary MEMS ultrasound sensor, or any other sensor that has at least a first portion 104 of exemplary MEMS sensor 102 and a second portion 112 of exemplary MEMS sensor 102, wherein the first portion 104 can be configured to generate a signal in response to a sensed stimulus (e.g., incident acoustic waves or pressure, etc.), and wherein the second portion 112 can be configured to receive a feedback signal 116 based on the generated signal to facilitate shaping the generated the signal or stimulus response of exemplary MEMS sensor 102, without limitation. It is further noted that while exemplary MEMS sensor system or apparatus 100 depicts exemplary MEMS sensor 102 as characterized by a variable capacitance (C_{MEMS}) that varies in response to the sensed stimulus (e.g., incident acoustic waves or pressure, etc.) for the purposes of illustration and not limitation, it can be understood that further examples of exemplary MEMS sensor 102, for which various non-limiting aspects as described herein can be applied, may not be so limited.

Nevertheless, as a further non-limiting example of exemplary MEMS sensor 102, exemplary MEMS sensor 102 can comprise an exemplary MEMS acoustic sensor, wherein an exemplary first portion 104 of exemplary MEMS sensor 102 can comprise a diaphragm (not shown) of exemplary MEMS acoustic sensor, and wherein an exemplary second portion 112 of exemplary MEMS sensor 102 can comprise a backplate (not shown) of an exemplary MEMS acoustic sensor. In another non-limiting example, exemplary feedback signal 116 can comprise a bias voltage feedback signal configured for, and/or that can be applied to, second portion 112 of exemplary MEMS sensor 102. Thus, in a non-limiting aspect, exemplary feedback signal 116 can comprise a bias voltage feedback signal configured for and/or applied to a second portion 112 comprising a backplate of an exemplary MEMS sensor 102 comprising an exemplary MEMS acoustic sensor or microphone. In further non-limiting aspect, exemplary feedback signal 116 can comprise an alternating current (AC) feedback signal 116 configured to be combined with a DC bias voltage (not shown) that can be applied to the second 112 portion of exemplary MEMS sensor 102. In addition, in yet another non-limiting aspect, exemplary feedback signal can be configured (e.g., via one or more of exemplary feedback component 110, one or more filter components 114, IC 106, and/or portions or combinations thereof, or otherwise, etc.) to one or more of reduce sensitivity of exemplary MEMS sensor 102 (e.g., MEMS, acoustic sensor, MEMS microphone sensor, MEMS ultrasound sensor, etc.), to increase AOP associated with exemplary MEMS sensor 102, to reduce a resonance peak associated with exemplary MEMS sensor 102, to reduce generated noise associated with exemplary MEMS sensor 102, to increase signal to noise ratio associated with exemplary MEMS sensor 102, and/or to modify frequency response of the MEMS sensor 102, and/or combinations thereof, and so on.

It can be understood that although IC 106 is depicted in FIG. 1 as comprising or being associated with one or more of exemplary feedback component 110 and one or more exemplary filter components 114, which are illustrated as discrete functional blocks, some portion or all of the one or more of exemplary feedback component 110 and one or more exemplary filter components 114 can be provided in an ASIC (not shown) with more or less functionality associated with the ASIC integrated therewith. As a non-limiting example, exemplary feedback component 110 can comprise one or more amplifier components that can be configured to generate an inverted output signal based on the output signal 108 and associated with the feedback signal 116, which functionality can be provided or facilitated by an exemplary ASIC, or otherwise. As another non-limiting example, one or more exemplary filter components 114 can comprise any of a combination of a low pass filter component (not shown), a high pass filter component (not shown), a band pass filter component (not shown), or a band stop filter component (not shown), arranged in any conceivable filter configuration of a parallel arrangement (not shown), a series arrangement (not shown), or a series-parallel arrangement (not shown) of one or more filters, of any filter order (e.g., a first-order filter, a higher order filter, etc.), and/or having fixed or adjustable filter parameters (e.g., filter parameters, etc.), which functionality can be provided or facilitated by an exemplary ASIC, or otherwise.

In another non-limiting aspect, one or more exemplary filter components 114 can comprise programmable or configurable switching circuitry which can facilitate switching feedback signal 116 according to one or more switching criteria, which functionality can be provided or facilitated by an exemplary ASIC, or otherwise. As another non-limiting example, exemplary MEMS sensor system or apparatus 100 can further comprise or be associated with an exemplary filter control component (not shown) that can be configured to control the one or more exemplary filter components 114, to switch the one or more exemplary filter components 114 between an on state and an off state, to modify performance of the one or more exemplary filter components 114, and so on, without limitation. As a non-limiting example, an exemplary filter control component can be configured to switch signal paths between an off-state, filtered, and/or unfiltered feedback for feedback signal 116, to switch signal paths between adjustable resistance and/or adjustable reactance paths for an exemplary resistor-capacitor (RC) filter associated with feedback signal 116, to switch signal paths between a network of two or more filters (e.g., a series arrangement, a parallel arrangement, a series parallel arrangement, etc.) associated with feedback signal 116, to switch signal paths to adjust the type (e.g., Butterworth, Chebyshev, Bessel, etc.), response (e.g., low pass, bandpass, high pass, etc.), and/or order (e.g.,) of one or more filters associated with feedback signal 116, and so on, without limitation. As a further non-limiting example, exemplary filter control component can be further configured to receive an input (e.g., from exemplary MEMS sensor 102, from a host system or device comprising exemplary MEMS sensor systems or apparatuses, a signal on a pin of an associated ASIC, etc.), and can comprise or be associated with logic (e.g., IC 106, a host system or device comprising exemplary MEMS sensor systems or apparatuses, etc.) to perform analysis and/or inference on such input to facilitate switching the one or more exemplary filter components 114 between an on state and an off state, and/or facilitate modifying performance of the one or more exemplary filter components 114 in accordance with the adjustable filter parameters (e.g., adjusting one or more adjustable filter parameters such as any of filter type, arrangement, response, on/off state, cutoff or corner frequency, etc., and/or combinations thereof, configured to alter the feedback signal 116 for the second portion 112 of exemplary MEMS sensor 102), and so on, without limitation.

In particular non-limiting aspects of exemplary MEMS sensor system or apparatus 100, exemplary MEMS sensor 102 can comprise an exemplary MEMS microphone sensor, wherein one or more exemplary filter components 114 can comprise an exemplary high pass filter component that can be configured to have a cutoff frequency of less than or equal to about 19 kiloHertz (kHz), without limitation. In still further particular non-limiting aspects of exemplary MEMS sensor system or apparatus 100, exemplary MEMS sensor 102 can comprise an exemplary MEMS ultrasound sensor, wherein one or more exemplary filter components 114 can comprise an exemplary low pass filter component that can be configured to have a corner frequency of greater than or equal to about 20 kHz, without limitation. In yet other particular non-limiting aspects of exemplary MEMS sensor system or apparatus 100, exemplary MEMS sensor 102 can comprise an exemplary MEMS ultrasound sensor, wherein one or more exemplary filter components 114 can comprise an exemplary low pass filter component that can be configured to have a corner frequency of greater than or equal to about 100 Hz, without limitation.

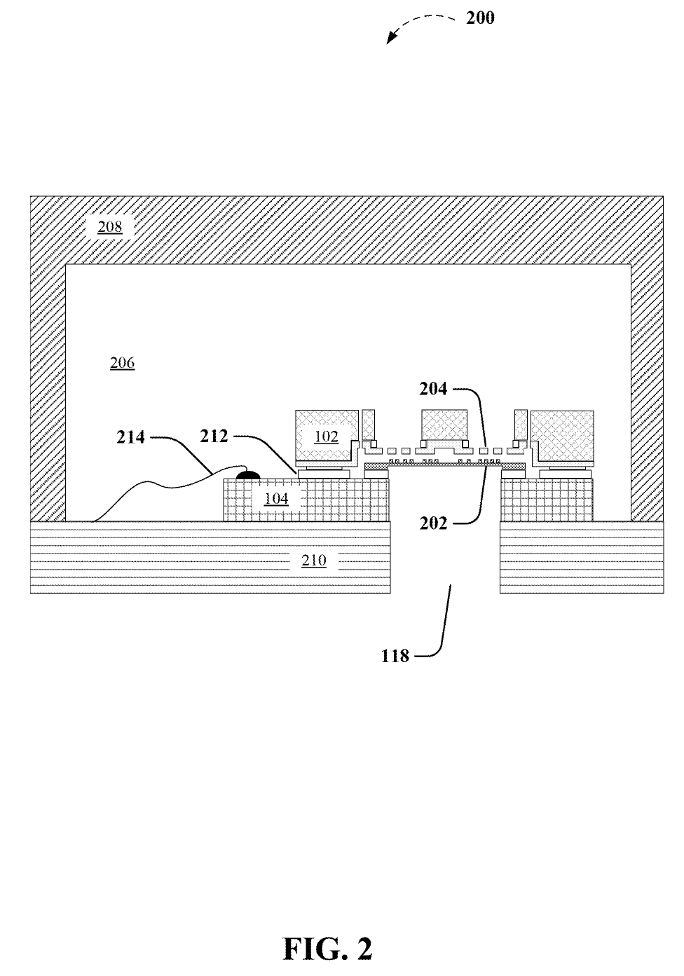

In still further non-limiting aspects, exemplary MEMS sensor system or apparatus 100 of FIG. 1, and/or portions thereof, can be comprised or associated with a MEMS sensor package comprising one or more of exemplary MEMS sensor 102, wherein exemplary IC 106, and/or portions thereof, functionality associated therewith, and so on, can be disposed in the MEMS sensor package, for example, as further described herein. For example, FIG. 2 depicts a non-limiting cross sectional diagram of an exemplary MEMS sensor package 200, in which an ASIC chip associated with a MEMS acoustic sensor or microphone (e.g., exemplary MEMS sensor system or apparatus 100, or portions thereof, etc.) is disposed, and which is suitable for incorporation of further non-limiting aspects of the subject disclosure. Accordingly, MEMS sensor package 200 can comprise a MEMS sensor 102, such as exemplary MEMS sensor 102 as described above regarding FIG. 1, for example, wherein exemplary MEMS sensor 102 can be associated with a particular resonance frequency. In further exemplary embodiments, MEMS sensor package 200 can also comprise an ASIC complementary metal oxide semiconductor (CMOS) chip (e.g., IC 106, and/or portions thereof, etc.) associated with exemplary MEMS sensor 102. In various aspects, exemplary MEMS sensor 102 can comprise a perforated backplate 202 (e.g., exemplary second portion 112 of exemplary MEMS sensor 102, etc.) that can act as a stationary electrode in concert with a diaphragm 204 (e.g., exemplary first portion 104 of exemplary MEMS sensor 102, etc.) to facilitate the transduction of incident acoustic waves or pressure into an electrical signal that can be communicatively coupled to IC 106, the result of which can provide an exemplary MEMS sensor 102 characterized by a variable capacitance (C_{MEMS}) that varies in response to the sensed stimulus (e.g., incident acoustic waves or pressure, etc.), as described above.

As further described above, exemplary MEMS sensor system or apparatus 100 of FIG. 1, and/or portions thereof, can be comprised or associated with a MEMS sensor package 200 comprising one or more of exemplary MEMS sensor 102, wherein exemplary IC 106, and/or portions thereof, functionality associated therewith, and so on, can be disposed in exemplary MEMS sensor package 200. Thus, in further non-limiting implementations, MEMS sensor package 200 can comprise a back cavity 206, which can be defined by a lid or cover 208 attached to package substrate 210, according to a non-limiting aspect.

In various non-limiting aspects, one or more of MEMS sensor 102, IC 106, and/or lid or cover 208 can be one or more of electrically coupled or mechanically affixed to package substrate 210, via methods available to those skilled in the art. As non-limiting examples, exemplary MEMS sensor 102 can be bonded 212 and electrically coupled to IC 106, and IC 106 can be bonded and electrically coupled (e.g., wire bonded 214) to package substrate 210. Thus, exemplary MEMS sensor 102, in the non-limiting example of MEMS sensor package 200, is mechanically, electrically, and/or communicatively coupled to the IC 106. Furthermore, lid or cover 208 and package substrate 210 together can comprise exemplary MEMS sensor package 200, to which a customer printed circuit board (PCB) (not shown) having an orifice or other means of passing acoustic waves to MEMS sensor 102 can be mechanically, electrically, and/or communicatively coupled. For example, acoustic waves can be received at exemplary MEMS sensor 102 via package substrate 210 having port 216 adapted to receive acoustic waves or pressure. An attached or coupled customer PCB (not shown) providing an orifice or other means of passing the acoustic waves or pressure facilitates receiving acoustic waves at exemplary MEMS sensor 102. Thus, FIG. 2 depicts MEMS sensor package 200 comprising exemplary MEMS sensor system or apparatus 100 of FIG. 1, and/or portions thereof, wherein exemplary IC 106, and/or portions thereof, functionality associated therewith, and so on, can be disposed in exemplary MEMS sensor package 200.

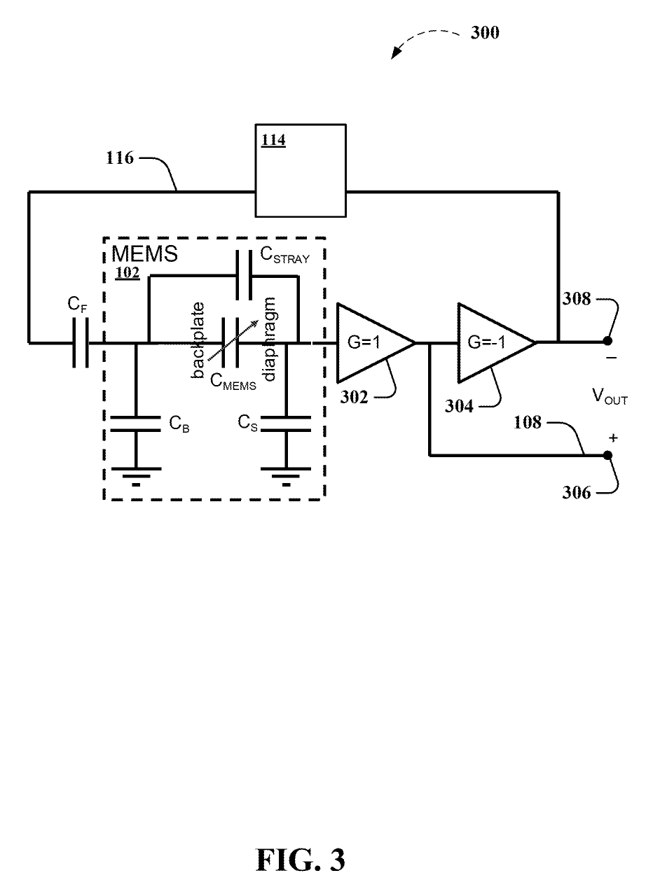

FIG. 3 depicts a non-limiting schematic diagram of an exemplary MEMS sensor system or apparatus 300 depicting an exemplary feedback technique, according to further non-limiting aspects of the subject disclosure. For instance, FIG. 3 provides an AC analysis block diagram for the one or more filter components 114 in a feedback loop comprising feedback signal 116, wherein C_{F} denotes feedback capacitance associated with exemplary IC 106, C_{B} denotes parasitic capacitance from backplate terminal to ground, C_{S} denotes parasitic capacitance from the diaphragm terminal to ground, C_{STRAY} denotes parasitic capacitance from diaphragm to backplate, and C_{MEMS} is the active capacitance of exemplary MEMS sensor 102, for an exemplary MEMS sensor 102 comprising, as a non-limiting example, a MEMS acoustic sensor or microphone. As a non-limiting example, exemplary MEMS sensor system or apparatus 300 can comprise an exemplary buffer amplifier 302 that can be configured to generate an output signal 108 associated with the first portion 104 (e.g., diaphragm) of exemplary MEMS sensor 102, for example, as further described herein. In another non-limiting example, exemplary MEMS sensor system or apparatus 300 can comprise an exemplary inverting amplifier 304 that can be configured to generate an inverted output signal based on the output signal 108 and associated with the feedback signal 116, which functionality can be provided or facilitated by an exemplary ASIC, or otherwise, for example, as further described herein.

In a non-limiting aspect, complete feedback (e.g., via unfiltered passthrough of one or more exemplary filter components 114) of an inverted diaphragm signal to backplate causes −6 dB at both (+) 306 output and (−) 308 output, compared to no feedback (e.g., cutoff of feedback via exemplary filter control component, for example, associated with one or more exemplary filter components 114). Thus, as determined for exemplary MEMS sensor 102 of exemplary MEMS sensor system or apparatus 300, MEMS loaded sensitivity=V_{OUT} at 94 dB SPL and AOP can be extended by 6 dB, whereas if feedback is stopped, the signal at both (+) 306 output and (−) 308 output is equal to MEMS loaded sensitivity at 94 dB SPL, the signal is 6 dB greater across V_{OUT}, and AOP returns to that of a normal MEMS sensor 102 without feedback applied. As further described herein, by enabling filtering in the feedback loop comprising feedback signal 116, according to various non-limiting aspects, disclosed embodiments can further selectively transition from this 0 dB to −6 dB relationship in frequency response and AOP, based on frequency.

In a non-limiting aspect, various embodiments as described herein can control frequency response of an associated exemplary MEMS sensor 102, based in part on frequency-specific application of feedback applied to exemplary MEMS sensor 102. As further described herein, employing a filter in a exemplary MEMS sensor 102 feedback loop, a transition from no feedback to complete feedback to exemplary MEMS sensor 102 can be controlled based on parameters of the filter, as a non-limiting example. Because feedback is happening before the input to the ASIC (e.g., the input buffer), the application of a negative feedback signal 116 based in part on frequency, exemplary embodiments as described herein can employ the apparent frequency shaping of the response of exemplary MEMS sensor 102. In another non-limiting example of a high pass filter in a negative feedback loop to a portion of exemplary MEMS sensor 102 (e.g., a backplate 202 of exemplary MEMS sensor 102 comprising a MEMS acoustic sensor or microphone, etc.), as a consequence of reducing the signal at high frequencies (e.g., around the resonant peak), improvements to AOP exemplary MEMS sensor 102 comprising a MEMS acoustic sensor or microphone by up to 6 dB are provided, whereas only the frequencies above the corner frequency are fed back to back plate 202, facilitating reduction of the resonant peak by up to 6 dB, reduction of high-frequency noise, improvement of high SPL source handling, etc.

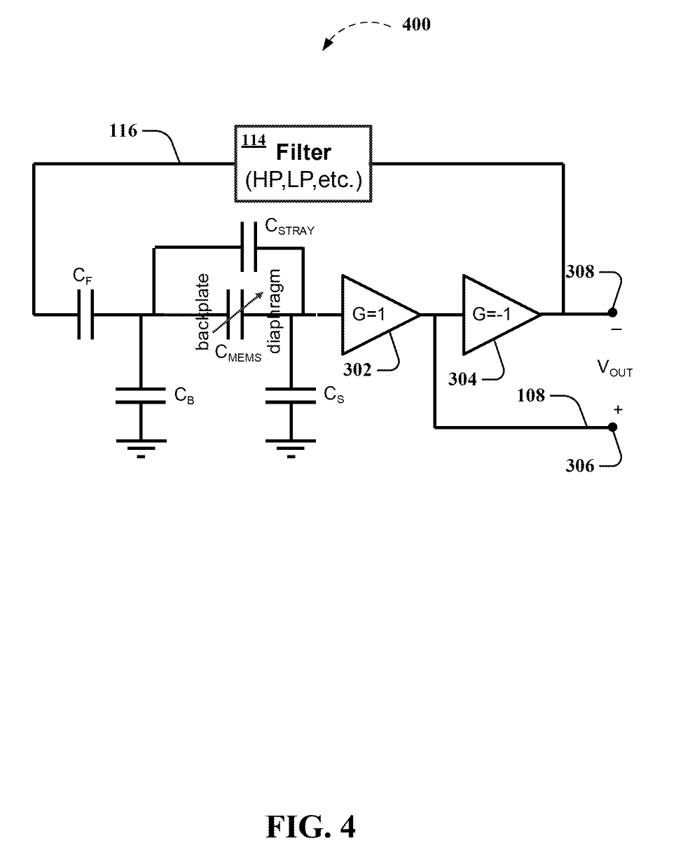

For example, FIG. 4 depicts another non-limiting schematic diagram of an exemplary MEMS sensor system or apparatus 400 depicting an exemplary feedback technique employing feedback filtering, according to non-limiting aspects as described herein. For instance, FIG. 4 provides an AC analysis block diagram for the one or more exemplary filter components 114 comprising a generic filter in a feedback loop comprising feedback signal 116, wherein the capacitance references are as described above regarding FIG. 3. As further described above, the one or more exemplary filter components 114 comprising a generic filter can comprise a filter of any type, such as a low pass filter, a high pass filter, a bandpass filter, a band stop filter, etc., and of any order (e.g., first-order, higher order, etc.), and/or arrangement (e.g., series, parallel, series parallel, etc.), and so on. It can be understood that the backplates depicted herein can have a static or DC bias voltage (not shown) applied to it, and exemplary feedback signal 116 can comprise an AC signal that can be combined with the static DC bias voltage, according to a non-limiting aspect, as further described herein. The result of feedback signal 116 (e.g., negative feedback signal 116) is a reduction in the apparent sensitivity and gain of exemplary MEMS sensor 102 of exemplary MEMS sensor system or apparatus 300, for which, in situations where there is no feedback signal 116 applied, typical sensitivity would be −32 dB volts (V)/Pascal, whereas with the feedback signal 116 applied, typical sensitivity would be −38 dBV/Pascal.

In various non-limiting embodiments, for frequencies where the one or more exemplary filter components 114 comprising a generic filter is allowing a signal to pass unfiltered, overall microphone output signal can be reduced by 6 dB and the AOP is increased by 6 dB, as further described herein. In a further non-limiting aspect, filtering facilitated by the one or more exemplary filter components 114 comprising a generic filter is effectively happening at exemplary MEMS sensor 102, before the exemplary buffer amplifier 302 (e.g., whether comprised by IC 106, or otherwise), and, as a result, AOP can be extended by 6 dB based on frequency as defined by the one or more exemplary filter components 114 comprising a generic filter. In contrast to conventional filtering applied to an exemplary MEMS sensor 102, where filtering is applied after an input/buffer stage (e.g., after exemplary buffer amplifier 302), it can be understood no benefit to AOP for exemplary MEMS sensor 102 can be achieved. As result, various non-limiting embodiments of the subject disclosure can facilitate shaping frequency response and noise spectrum for exemplary MEMS sensor 102 with a −6 dB shelving response, without affecting output impedance of an associated MEMS sensor ASIC and associated THD, such as in the case of employing an output capacitor to shape exemplary MEMS sensor 102 output frequency response.

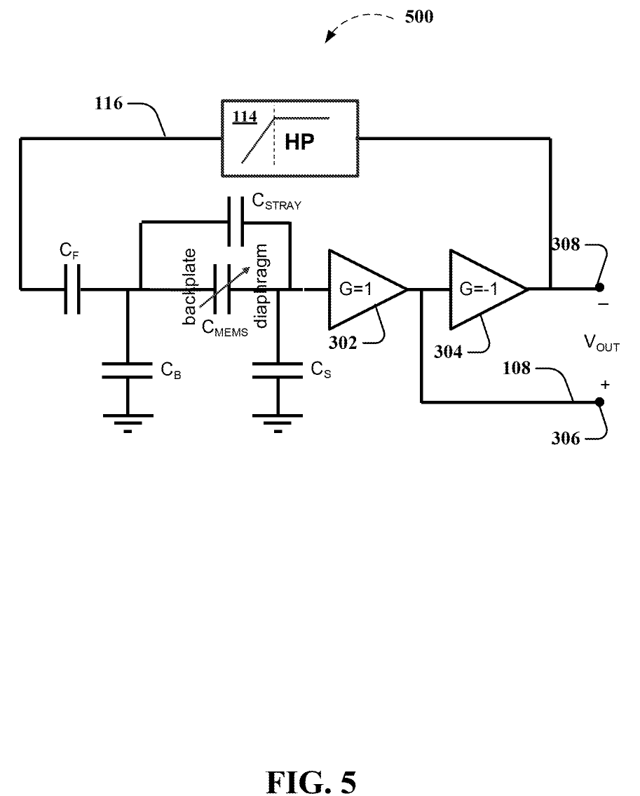

As another non-limiting example, FIG. 5 depicts a further non-limiting schematic diagram of a particular exemplary embodiment of a MEMS sensor system or apparatus 500 that demonstrates an exemplary feedback technique employing feedback filtering, according to further non-limiting aspects as described herein. For instance, FIG. 5 depicts a particular non-limiting embodiment where the one or more exemplary filter components 114 comprise an exemplary first-order, high pass filter is placed feedback path associated with feedback signal 116 of the inverted output of exemplary inverting amplifier 304 applied to the backplate of exemplary MEMS sensor 102, for the purpose of illustration, and not limitation, wherein the capacitance references are as described above regarding FIG. 3. In a non-limiting aspect, exemplary embodiment MEMS sensor system or apparatus 500 can facilitate reducing the output signal level associated with exemplary MEMS sensor 102 by up to 6 dB and can facilitate increasing AOP above the cutoff frequency of the exemplary first-order, high pass filter. For example, it can be understood that only frequencies above the cutoff frequency are allowed to be fed back by the one or more exemplary filter components 114 comprise an exemplary first-order, high pass filter, such that the resonant peak can be reduced in amplitude, for example, by up to 6 dB as further demonstrated herein, whereas high-frequency noise can be reduced, thus increasing SNR, and high-frequency, high-SPL handling can be improved, compared to no feedback.

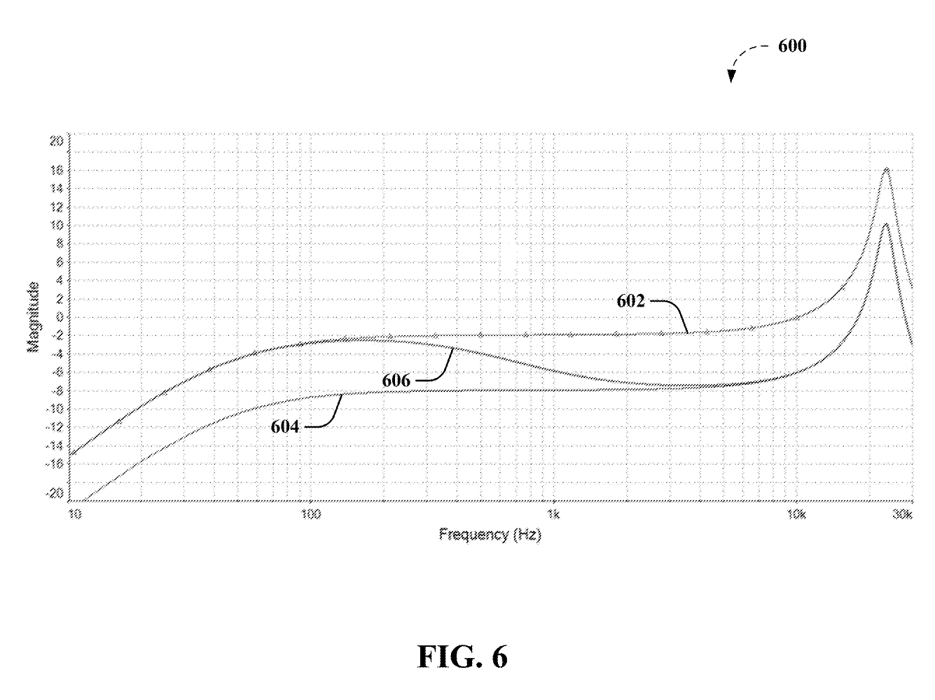

FIG. 6 depicts simulated frequency response 600 of exemplary MEMS sensor systems or apparatuses (e.g., exemplary MEMS sensor system or apparatus 100, 300, 400, 500, etc.) employing non-limiting aspects of feedback filtering techniques according to non-limiting embodiments as described herein. For instance, FIG. 6 shows exemplary simulated frequency responses of three scenarios, comprising exemplary MEMS sensor 102 with no feedback 602 to the backplate, exemplary MEMS sensor 102 with full-frequency feedback 604 to the backplate, and exemplary MEMS sensor 102 with an exemplary 1 kHz first-order, high pass filter in the feedback path 606 to the backplate, for the purpose of illustration, and not limitation.

While exemplary simulated frequency response for exemplary MEMS sensor 102 with an exemplary 1 kilohertz (kHz) first-order, high pass filter in the feedback path 606 to the backplate may not necessarily be a desirable frequency response for exemplary MEMS sensor 102, the relative behavior of the simulated frequency responses illustrates the principle of transitioning between regions of no feedback 602 and full feedback 604 based on filter type and corner or cutoff frequency. As a non-limiting example, only frequencies above (or below for a low pass filter) the corner or cutoff frequency are fed back, such that the resonant peak can be reduced in amplitude, as further described herein, whereas high-frequency noise can be reduced, thus increasing SNR, and high-frequency, high-SPL handling can be improved, compared to no feedback 602.

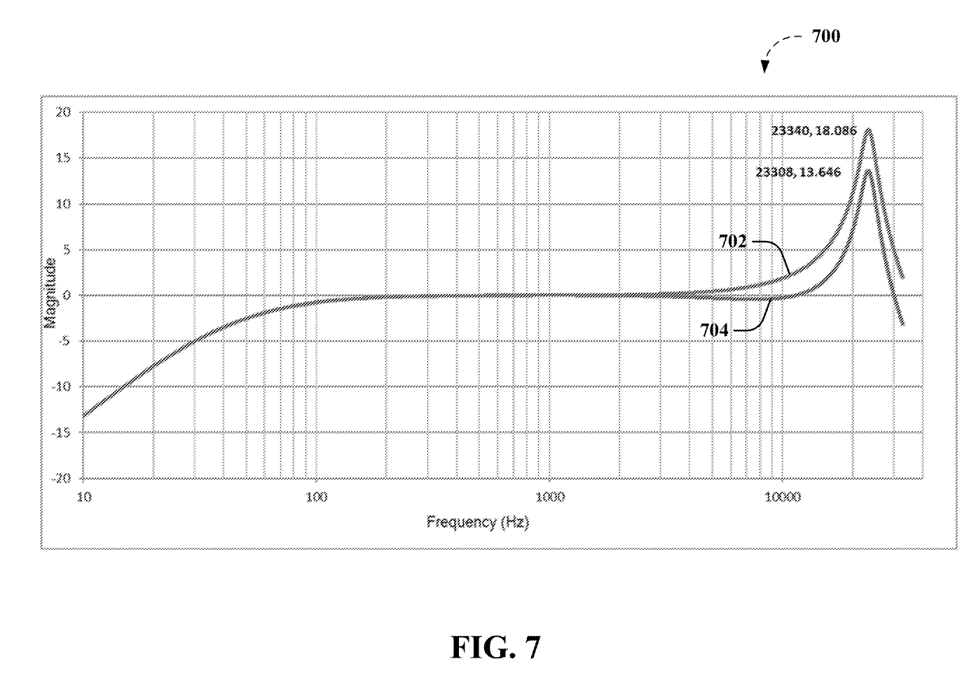

FIG. 7 depicts simulated, normalized frequency responses 700 of a lumped element model simulation of exemplary MEMS sensor systems or apparatuses (e.g., exemplary MEMS sensor system or apparatus 100, 300, 400, 500, etc.) employing non-limiting aspects of feedback filtering techniques used to simulate various filter types and filter frequencies versus no feedback 702 and filtered feedback 704, according to further non-limiting aspects of the subject disclosure. For instance, FIG. 7 shows the resultant normalized frequency responses of a lumped element model (employing high-pass-filtered feedback with a first-order, high pass filter with a 19 kHz cutoff frequency), with and without the 19 kHz, first-order, high-pass filter in the feedback loop associated with feedback signal 116. As depicted in FIG. 7, resonant peak for an exemplary MEMS sensor 102 can be reduced by 4.4 dB, and from 2 kHz and above, AOP can be increased.

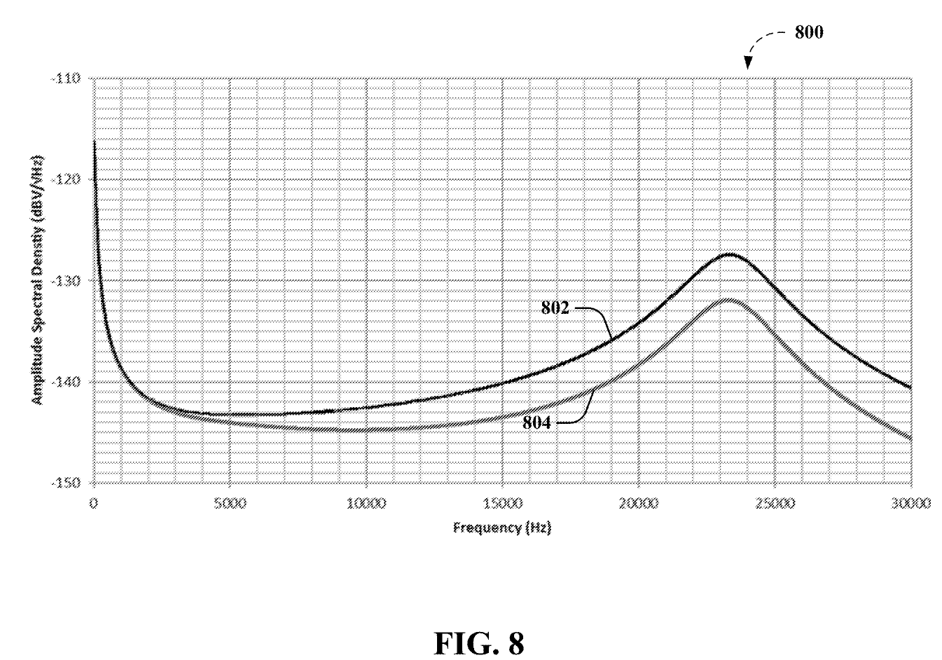

FIG. 8 depicts noise amplitude spectral densities 800 according to simulated, normalized frequency responses of the lumped element model simulation of exemplary MEMS sensor systems or apparatuses (e.g., exemplary MEMS sensor system or apparatus 100, 300, 400, 500, etc.) described with reference to FIG. 7. For instance, FIG. 8 depicts noise amplitude spectral densities for an exemplary MEMS sensor 102, according to non-limiting aspects (e.g., employing high-pass-filtered feedback with a first-order, high pass filter with a 19 kHz cutoff frequency), with and without the 19 kHz, first-order, high-pass filter in the feedback loop associated with feedback signal 116, which shows the difference in amplitude-weighted integrated noise is 1.2 dB, and thus, a 1.2 dB improvement in SNR for an exemplary MEMS sensor 102.

Accordingly, various non-limiting embodiments of disclosed exemplary MEMS sensor systems or apparatuses 100, 200, 300, 400, 500, etc., (e.g., comprising exemplary MEMS sensor 102, exemplary IC 106, and/or portions thereof, etc.) can comprise an exemplary MEMS sensor 102, wherein the MEMS sensor is configured to provide an electrical signal.

Further non-limiting implementations of disclosed exemplary MEMS sensor systems or apparatuses 100, 200, 300, 400, 500, etc., (e.g., comprising exemplary MEMS sensor 102, exemplary IC 106, and/or portions thereof, etc.) can comprise means for receiving the electrical signal from exemplary MEMS sensor 102. As a non-limiting example, exemplary means for receiving electrical signal from exemplary MEMS sensor 102 can comprise one or more of IC 106, exemplary buffer amplifier 302, exemplary feedback component 110, one or more exemplary filter components 114, electrical coupling of exemplary MEMS sensor 102 with exemplary IC 106, and/or combinations or portions thereof, and so on.

Still further non-limiting implementations of disclosed exemplary MEMS sensor systems or apparatuses 100, 200, 300, 400, 500, etc., (e.g., comprising exemplary MEMS sensor 102, exemplary IC 106, and/or portions thereof, etc.) can comprise means for generating an output signal 108 associated with a first portion 104 of exemplary MEMS sensor 102. As further described herein, exemplary means for generating an output signal 108 associated with a first portion 104 of exemplary MEMS sensor 102 can comprise one or more of IC 106, exemplary buffer amplifier 302, exemplary feedback component 110, one or more exemplary filter components 114, electrical coupling of exemplary MEMS sensor 102 with exemplary IC 106, and/or combinations or portions thereof, and so on.

In addition, further non-limiting implementations of disclosed exemplary MEMS sensor systems or apparatuses 100, 200, 300, 400, 500, etc., (e.g., comprising including exemplary MEMS sensor 102, exemplary IC 106, and/or portions thereof, etc.) can comprise means for generating a feedback signal 116 based on the output signal 108 for a second portion 112 of exemplary MEMS sensor 102. As a further non-limiting example, exemplary means for generating a feedback signal 116 based on the output signal 108 for a second portion 112 of exemplary MEMS sensor 102 can comprise one or more of IC 106, exemplary inverting amplifier 304, exemplary feedback component 110, one or more exemplary filter components 114, electrical coupling of exemplary MEMS sensor 102 with exemplary IC 106, and/or combinations or portions thereof, and so on.

Still further non-limiting implementations of disclosed exemplary MEMS sensor systems or apparatuses 100, 200, 300, 400, 500, etc., (e.g., comprising exemplary MEMS sensor 102, exemplary IC 106, and/or portions thereof, etc.) can comprise means for filtering the feedback signal 116 for transmission to the second portion 112 of exemplary MEMS sensor 102. In a further non-limiting example, exemplary means for filtering the feedback signal 116 for transmission to the second portion 112 of exemplary MEMS sensor 102 can comprise one or more of IC 106, exemplary inverting amplifier 304, exemplary feedback component 110, one or more exemplary filter components 114, electrical coupling of exemplary MEMS sensor 102 with exemplary IC 106, and/or combinations or portions thereof, and so on.

In addition, as further described herein, further non-limiting implementations of disclosed exemplary MEMS sensor systems or apparatuses 100, 200, 300, 400, 500, etc., (e.g., comprising exemplary MEMS sensor 102, exemplary IC 106, and/or portions thereof, etc.) can comprise a MEMS sensor package (e.g., exemplary MEMS sensor package 200, etc.) comprising exemplary MEMS sensor 102, the means for receiving, the means for generating the output signal 108, the means for generating the feedback signal 116, and the means for filtering. In still another non-limiting aspect, as further described herein, exemplary MEMS sensor 102 can comprise a MEMS acoustic sensor, wherein the first portion 104 of exemplary MEMS sensor 102 can comprise a diaphragm 204 of the MEMS acoustic sensor, wherein the second portion 112 of the MEMS sensor can comprise a backplate 202 of the MEMS acoustic sensor, and wherein the feedback signal 116 can comprises a bias voltage feedback signal for the second portion 112 of exemplary MEMS sensor 102.

However, various exemplary implementations of exemplary MEMS sensor systems or apparatuses as described can additionally, or alternatively, include other features or functionality of MEMS sensors, associated ICs, sensors packages, and so on, as further detailed herein, for example, regarding FIGS. 1-5. In addition, while various non-limiting implementations have been described herein for the purposes of illustration, and not limitation, it can be understood that various alterations and/or modifications are available to those skilled in the art. As a non-limiting examples, while various embodiments are described herein in reference to exemplary MEMS sensor 102 comprising a MEMS acoustic sensor or microphone for the purposes of illustration, and not limitation, it can be understood that various embodiments as described herein can be employed in any kind of sensor system (e.g., a MEMS condenser sensor microphone, MEMS ultrasonic transducers, other MEMS sensor mechanisms where it is desirable to shape the frequency response as provided herein, etc.), and/or employed in any of a number of combinations, specifications (e.g., type and/or corner or cutoff frequency of filters) and/or arrangements of filters, as further described herein.

As further non-limiting examples, changing a filter type or parameters such as corner or cutoff frequency, various embodiments as described herein can enable other applications of exemplary MEMS sensor 102. For example, in non-limiting aspects, a low-pass filter associated with feedback signal 116 with a corner frequency to 20 kHz or higher could facilitate providing a 6 dB increase in exemplary MEMS sensor 102 response relative to 1 kHz sensitivity, which could facilitate applications of exemplary MEMS sensor 102 such as motion or location sensing, ultrasonic data transfer, and so on, by extending capabilities of exemplary MEMS sensor 102 into ultrasonic frequencies, boosting the natural response of the exemplary MEMS sensor 102, etc. In still further non-limiting aspects, control of low-frequency corner and low-frequency AOP can be about by employing a low-pass filter associated with feedback signal 116 at 100 Hz, for example, thereby imposing a low-frequency shelf in exemplary MEMS sensor 102 frequency response, which can facilitate handling higher SPL in that region, and which could be preferable for improving exemplary MEMS sensor 102 SNR over decreasing vent resistance or backvolume (e.g., requiring one-off and/or costly MEMS sensor device fabrication and/or implementation changes) to achieve similar frequency response goals.

In addition, while various embodiments are described herein in reference to a host system or application comprising a mobile device for the purposes of illustration, it can be understood that various embodiments as described herein can be employed in any kind of host system or application, without limitation. Moreover, while various embodiments are described herein in reference to specific numbers of components, outputs, etc. for the purposes of illustration, it can be understood that various embodiments as described herein can be employed in virtually any configuration with respect to components and subcomponents, portions thereof, and/or combinations and/or distributions thereof, and so on, without limitation.

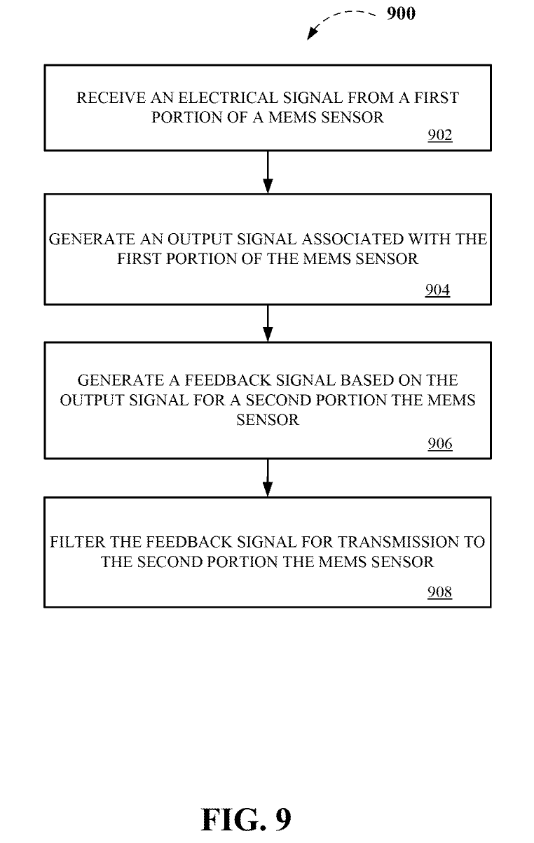

In view of the subject matter described supra, methods that can be implemented in accordance with the subject disclosure will be better appreciated with reference to the flowchart of FIG. 9. While for purposes of simplicity of explanation, the methods are shown and described as a series of blocks, it is to be understood and appreciated that such illustrations or corresponding descriptions are not limited by the order of the blocks, as some blocks may occur in different orders and/or concurrently with other blocks from what is depicted and described herein. Any non-sequential, or branched, flow illustrated via a flowchart should be understood to indicate that various other branches, flow paths, and orders of the blocks, can be implemented which achieve the same or a similar result. Moreover, not all illustrated blocks may be required to implement the methods described hereinafter.

### Exemplary Methods

FIG. 9 depicts an exemplary flowchart of non-limiting methods 900 associated with exemplary MEMS sensor systems or apparatuses (e.g., exemplary MEMS sensor 102 of exemplary MEMS sensor systems or apparatuses 100, 200, 300, 400, 500, etc.) employing feedback filtering, according to various non-limiting aspects of the disclosed subject matter. As a non-limiting example, exemplary methods 900 can comprise receiving an electrical signal from a first portion 104 of MEMS sensor 102, at 902. As further described herein, various non-limiting embodiments of exemplary MEMS sensor system or apparatus 100 can comprise one or more of MEMS sensor 102 and electrical circuitry configured to receive an electrical signal from a first portion 104 of MEMS sensor 102. In a non-limiting aspect, exemplary electrical circuitry can comprise or be associated with exemplary IC 106.

In further non-limiting examples, at 904, exemplary methods 900 can comprise generating an output signal 108 associated with the first portion 104 of MEMS sensor 102. As further described above, in yet another non-limiting aspect, the electrical circuitry can be further configured to generate an output signal 108 associated with the first portion 104 of MEMS sensor 102. In addition, non-limiting methods 900 associated with exemplary MEMS sensor systems or apparatuses (e.g., exemplary MEMS sensor 102 of exemplary MEMS sensor systems or apparatuses 100, 200, 300, 400, 500, etc.) can further comprise generating a feedback signal 116 based on output signal 108 for a second portion 112 of exemplary MEMS sensor 102, at 906.

For example, as further described herein, exemplary feedback component 110 can comprise one or more amplifier components that can be configured to generate an inverted output signal based on the output signal 108 and associated with the feedback signal 116, which functionality can be provided or facilitated by an exemplary ASIC, or otherwise. As another non-limiting example, one or more exemplary filter components 114 can comprise any of a combination of a low pass filter component, a high pass filter component, a band pass filter component, or a band stop filter component, arranged in any conceivable filter configuration of a parallel arrangement, a series arrangement, or a series-parallel arrangement of one or more filters, of any filter order (e.g., a first-order filter, a higher order filter, etc.), and/or having fixed or adjustable filter parameters (e.g., filter parameters, etc.), which functionality can be provided or facilitated by an exemplary ASIC, or otherwise.

As further described herein, exemplary MEMS sensor 102 can comprise an exemplary MEMS acoustic sensor, wherein an exemplary first portion 104 of exemplary MEMS sensor 102 can comprise a diaphragm (e.g., diaphragm 204, etc.) of exemplary MEMS acoustic sensor, and wherein an exemplary second portion 112 of exemplary MEMS sensor 102 can comprise a backplate (e.g., backplate 202, etc.) of an exemplary MEMS acoustic sensor. In another non-limiting example, exemplary feedback signal 116 can comprise a bias voltage feedback signal configured for, and/or that can be applied to, second portion 112 of exemplary MEMS sensor 102. Thus, in a non-limiting aspect, exemplary feedback signal 116 can comprise a bias voltage feedback signal configured for and/or applied to a second portion 112 comprising a backplate of an exemplary MEMS sensor 102 comprising an exemplary MEMS acoustic sensor or microphone. Accordingly, in another non-limiting aspect, exemplary methods 900 can comprise generating a bias voltage feedback signal 116 for the second portion 112 of exemplary MEMS sensor 102. For example, as further described herein, exemplary feedback signal 116 can comprise an AC feedback signal 116 configured to be combined with a DC bias voltage can be applied to the second 112 portion of exemplary MEMS sensor 102. Accordingly, in still another non-limiting aspect, exemplary methods 900 can further comprise generating an AC feedback signal 116, as further described herein.

In other non-limiting examples of exemplary methods 900, exemplary methods 900 can further comprise filtering the feedback signal 116 for transmission to the second portion 112 of exemplary MEMS sensor 102, at 908. In a non-limiting aspect, exemplary methods 900 can comprise one or more of generating and filtering the feedback signal in an IC (e.g., exemplary IC 106, and/or portions thereof, etc.) associated with exemplary MEMS sensor 102. As further described herein, non-limiting embodiments of exemplary methods 900 can further comprise combining the AC feedback signal 116 with a DC bias voltage applied to the second portion 112 of exemplary MEMS sensor 102. In addition, in yet another non-limiting aspect, exemplary feedback signal can be configured (e.g., via one or more of exemplary feedback component 110, one or more filter components 114, IC 106, and/or portions or combinations thereof, or otherwise, etc.) to one or more of reduce sensitivity of exemplary MEMS sensor 102 (e.g., MEMS, acoustic sensor, MEMS microphone sensor, MEMS ultrasound sensor, etc.), to increase AOP associated with exemplary MEMS sensor 102, to reduce a resonance peak associated with exemplary MEMS sensor 102, to reduce generated noise associated with exemplary MEMS sensor 102, to increase signal to noise ratio associated with exemplary MEMS sensor 102, and/or to modify frequency response of the MEMS sensor 102, and/or combinations thereof, and so on.

In another non-limiting aspect, one or more exemplary filter components 114 can comprise programmable or configurable switching circuitry which can facilitate switching feedback signal 116 according to one or more switching criteria, which functionality can be provided or facilitated by an exemplary ASIC, or otherwise. As another non-limiting example, exemplary MEMS sensor system or apparatus 100 can further comprise or be associated with an exemplary filter control component (not shown) that can be configured to control the one or more exemplary filter components 114, to switch the one or more exemplary filter components 114 between an on state and an off state, to modify performance of the one or more exemplary filter components 114, and so on, without limitation. As a non-limiting example, an exemplary filter control component can be configured to switch signal paths between an off-state, filtered, and/or unfiltered feedback for feedback signal 116, to switch signal paths between adjustable resistance and/or adjustable reactance paths for an exemplary resistor-capacitor (RC) filter associated with feedback signal 116, to switch signal paths between a network of two or more filters (e.g., a series arrangement, a parallel arrangement, a series parallel arrangement, etc.) associated with feedback signal 116, to switch signal paths to adjust the type (e.g., Butterworth, Chebyshev, Bessel, etc.), response (e.g., low pass, bandpass, high pass, etc.), and/or order (e.g.,) of one or more filters associated with feedback signal 116, and so on, without limitation. As a further non-limiting example, exemplary filter control component can be further configured to receive an input (e.g., from exemplary MEMS sensor 102, from a host system or device comprising exemplary MEMS sensor systems or apparatuses, a signal on a pin of an associated ASIC, etc.), and can comprise or be associated with logic (e.g., IC 106, a host system or device comprising exemplary MEMS sensor systems or apparatuses, etc.) to perform analysis and/or inference on such input to facilitate switching the one or more exemplary filter components 114 between an on state and an off state, and/or facilitate modifying performance of the one or more exemplary filter components 114 in accordance with the adjustable filter parameters (e.g., adjusting one or more adjustable filter parameters such as any of filter type, arrangement, response, on/off state, cutoff or corner frequency, etc., and/or combinations thereof, configured to alter the feedback signal 116 for the second portion 112 of exemplary MEMS sensor 102), and so on, without limitation. Accordingly, in yet another non-limiting aspect, exemplary methods 900 can further comprise adjusting one or more adjustable filter parameters (e.g., filter type, arrangement, response, on/off state, cutoff or corner frequency, etc.) configured to alter the feedback signal 116 for the second portion 112 of exemplary MEMS sensor 102.

### Exemplary Host System or Device

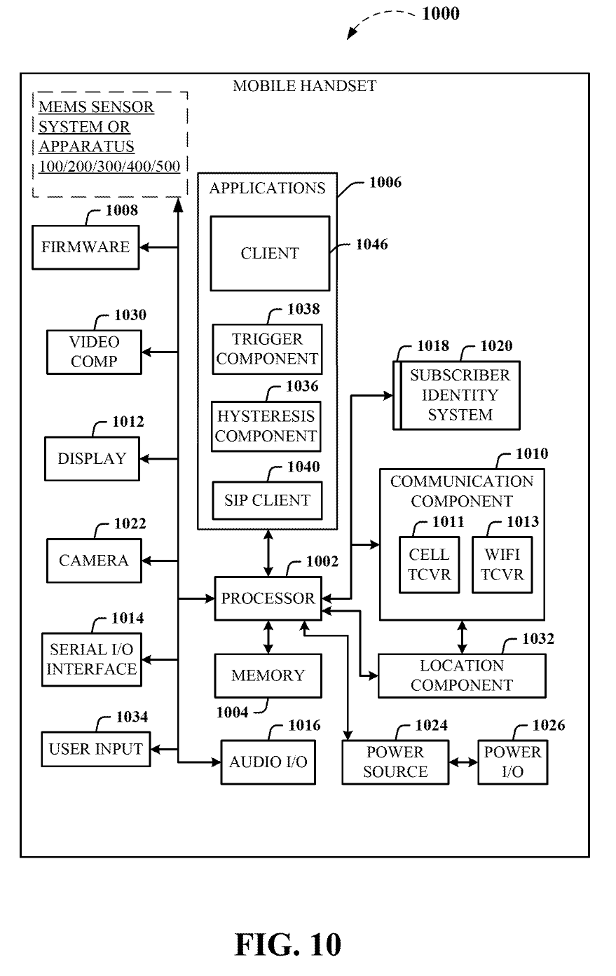

FIG. 10 illustrates a schematic diagram of an exemplary host system or device (e.g., a mobile handset) that can facilitate various non-limiting aspects of the subject disclosure in accordance with the embodiments described herein. Accordingly, exemplary mobile device can comprise or be associated with exemplary MEMS sensor 102, and/or portions or combinations thereof, as well as other disclosed components, devices, features, functionality, logic configured according to provided designs, portions thereof, and so on, without limitation. Although mobile handset 1000 is illustrated herein, it will be understood that other devices, whether mobile devices or otherwise, can facilitate various non-limiting aspects of the subject disclosure. In accordance with the embodiments described herein, exemplary devices suitable for performing various aspects described herein can include, without limitation, a sensor package and/or associated signal processing components such as ASICs (e.g., exemplary IC 106, and/or portions thereof, etc.) and the like, a desktop computer, a cellular phone, a laptop computer, a tablet personal computer (PC) device, and/or a personal digital assistant (PDA), or other mobile device, and so on comprising various embodiments of exemplary MEMS sensor systems or apparatuses 100, 200, 300, 400, 500, etc. As further examples, exemplary devices suitable for performing various aspects described herein can include, without limitation, cameras, global positioning system (GPS) devices, and other such devices as a pen computing device, portable digital music player, home entertainment devices, network capable devices, appliances, kiosks, and sensors, and so on. It is to be understood that exemplary mobile device 1000 can comprise more or less functionality than those exemplary devices described above, as the context requires, and as further described herein.

As described above, exemplary MEMS sensor systems or apparatuses 100, 200, 300, 400, 500, etc., as described herein, can facilitate modifying frequency response, increasing an AOP, reducing a resonance peak associated with exemplary MEMS sensor 102, reducing generated noise associated with exemplary MEMS sensor 102, increasing signal to noise ratio associated with exemplary MEMS sensor 102, and/or combinations thereof, and so on. As a non-limiting example, mobile device 1000 can have multiple operating environments (e.g., low SPL, high SPL, specific energy located about a particular frequency or to be avoided at that particular frequency, etc.) and/or device preferences (e.g., high-frequency, high-SPL handling, low-frequency, high-SPL handling, etc.), for which, exemplary MEMS sensor systems or apparatuses 100, 200, 300, 400, 500, etc., as described herein, are directed. Thus, exemplary MEMS sensor systems or apparatuses 100, 200, 300, 400, 500, etc., can facilitate meeting such disparate requirements, while providing improvements over conventional techniques.

Accordingly, as further described above regarding FIGS. 1-5, non-limiting implementations of exemplary MEMS sensor systems or apparatuses 100, 200, 300, 400, 500, etc., (e.g., comprising a MEMS sensor package including exemplary MEMS sensor 102, exemplary IC 106, and/or portions thereof, etc.) can be configured to generate an output signal 108 associated with a first portion 104 of exemplary MEMS sensor 102, to generate a feedback signal 116 based on the output signal 108 for a second portion 112 of MEMS sensor, to filter the feedback signal 116 for the second portion 112 the MEMS sensor, and/or to one or more of switch between an on state and an off state for feedback signal 116 or modify performance of the filter (e.g., one or more filter components 114). Thus, in a non-limiting example, exemplary host system or device (e.g., mobile device 1000, etc.) can be configured to receive an output signal 108 associated with exemplary MEMS sensor 102. As a further non-limiting example, various embodiments of exemplary MEMS sensor systems or apparatuses 100, 200, 300, 400, 500, etc., (e.g., comprising a MEMS sensor package including exemplary MEMS sensor 102, exemplary IC 106, and/or portions thereof, etc.) can comprise a filter control component that can be further configured to receive an input signal from the host system or device (e.g., mobile device 1000, etc.) to facilitate switching the one or more exemplary filter components 114 between an on state and an off state, and/or facilitate modifying performance of the one or more exemplary filter components 114, and so on, without limitation, based in part on the input signal from the host system or device (e.g., mobile device 1000, etc.).

While exemplary host system or device comprising mobile device 1000 is merely illustrated to provide context for the embodiments of the subject matter described herein, the following discussion is intended to provide a brief, general description of an example of a suitable environment 1000 in which the various embodiments can be implemented. While the description includes a general context of computer-executable instructions embodied on a non-transitory computer readable storage medium, those skilled in the art will recognize that the subject matter also can be implemented in combination with other program modules or components and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of computer-readable media. Computer readable media can comprise any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable communications media as distinguishable from computer-readable storage media.

The handset 1000 can include a processor 1002 for controlling and processing all onboard operations and functions. A memory 1004 interfaces to the processor 1002 for storage of data and one or more applications 1006 (e.g., communications applications such as IM, SMS, and/or other application specifically targeted to performance or use of exemplary MEMS sensor 102, etc.). The applications 1006 can be stored in the memory 1004 and/or in a firmware 1008, and executed by the processor 1002 from either or both the memory 1004 or/and the firmware 1008. The firmware 1008 can also store startup code for execution in initializing the handset 1000. A communications component 1010 interfaces to the processor 1002 to facilitate wired/wireless communication with external systems, e.g., cellular networks, VoIP networks, and so on. Here, the communications component 1010 can also include a suitable cellular transceiver 1011 (e.g., a GSM transceiver) and/or an unlicensed transceiver 1013 (e.g., Wireless Fidelity (WiFi™), Worldwide Interoperability for Microwave Access (WiMax®)) for corresponding signal communications. The communications component 1010 also facilitates communications reception from terrestrial radio networks (e.g., broadcast), digital satellite radio networks, and Internet-based radio services networks.

The handset 1000 includes a display 1012 for displaying text, images, video, telephony functions (e.g., a Caller ID function), setup functions, and for user input. For example, the display 1012 can also be referred to as a “screen” that can accommodate the presentation of multimedia content (e.g., music metadata, messages, wallpaper, graphics, etc.). The display 1012 can also display videos and can facilitate the generation, editing and sharing of video quotes. A serial I/O interface 1014 is provided in communication with the processor 1002 to facilitate wired and/or wireless serial communications (e.g., Universal Serial Bus (USB), and/or Institute of Electrical and Electronics Engineers (IEEE) 2394) through a hardwire connection, and other serial input devices (e.g., a keyboard, keypad, and mouse). This supports updating and troubleshooting the handset 1000, for example. Audio capabilities are provided with an audio I/O component 1016, which can include a speaker for the output of audio signals related to, for example, indication that the user pressed the proper key or key combination to initiate the user feedback signal. The audio I/O component 1016 also facilitates the input of audio signals through a microphone (e.g., such as a exemplary MEMS sensor 102 comprising a MEMS acoustic sensor or microphone, etc.) to record data and/or telephony voice data, and for inputting voice signals for telephone conversations.

The handset 1000 can include a slot interface 1018 for accommodating a SIC (Subscriber Identity Component) in the form factor of a card Subscriber Identity Module (SIM) or universal SIM 1020, and interfacing the SIM card 1020 with the processor 1002. However, it is to be appreciated that the SIM card 1020 can be manufactured into the handset 1000, and updated by downloading data and software.

The handset 1000 can process Internet Protocol (IP) data traffic through the communication component 1010 to accommodate IP traffic from an IP network such as, for example, the Internet, a corporate intranet, a home network, a person area network, etc., through an ISP or broadband cable provider. Thus, VoIP traffic can be utilized by the handset 1000 and IP-based multimedia content can be received in either an encoded or a decoded format.

A video processing component 1022 (e.g., a camera) can be provided for decoding encoded multimedia content. The video processing component 1022 can aid in facilitating the generation and/or sharing of video. The handset 1000 also includes a power source 1024 in the form of batteries and/or an alternating current (AC) power subsystem, which power source 1024 can interface to an external power system or charging equipment (not shown) by a power input/output (I/O) component 1026.

The handset 1000 can also include a video component 1030 for processing video content received and, for recording and transmitting video content. For example, the video component 1030 can facilitate the generation, editing and sharing of video. A location-tracking component 1032 facilitates geographically locating the handset 1000. A user input component 1034 facilitates the user inputting data and/or making selections as previously described. The user input component 1034 can also facilitate selecting or transmitting an input (e.g., for exemplary MEMS sensor 102, from host system or device 1000 comprising exemplary MEMS sensor systems or apparatuses, for setting a signal on a pin of an associated ASIC, etc.), and comprising or associated with logic (e.g., IC 106, host system or device 1000 comprising exemplary MEMS sensor systems or apparatuses, etc.) to perform analysis and/or inference on an output signal associated with exemplary MEMS sensor 102 to facilitate switching the one or more exemplary filter components 114 between an on state and an off state, and/or facilitate modifying performance of the one or more exemplary filter components 114 in accordance with the adjustable filter parameters (e.g., adjusting one or more adjustable filter parameters such as any of filter type, arrangement, response, on/off state, cutoff or corner frequency, etc., and/or combinations thereof, configured to alter the feedback signal 116 for the second portion 112 of exemplary MEMS sensor 102), as well as composing messages and other user input tasks as required by the context. The user input component 1034 can include such conventional input device technologies such as a keypad, keyboard, mouse, stylus pen, and/or touch screen, for example.

Referring again to the applications 1006, a hysteresis component 1036 facilitates the analysis and processing of hysteresis data, which is utilized to determine when to associate with an access point. A software trigger component 1038 can be provided that facilitates triggering of the hysteresis component 1038 when a WiFi™ transceiver 1013 detects the beacon of the access point. A SIP client 1040 enables the handset 1000 to support SIP protocols and register the subscriber with the SIP registrar server. The applications 1006 can also include a communications application or client 1046 that, among other possibilities, can be a target for an audio or application or plugin (e.g., such as an equalizer or other application, etc.) or user interface component functionality as described above.

The handset 1000, as indicated above related to the communications component 1010, includes an indoor network radio transceiver 1013 (e.g., WiFi transceiver). This function supports the indoor radio link, such as IEEE 1002.11, for the dual-mode Global System for Mobile Communications (GSM) handset 1000. The handset 1000 can accommodate at least satellite radio services through a handset that can combine wireless voice and digital radio chipsets into a single handheld device.

It can be understood that while a brief overview of exemplary systems, methods, scenarios, and/or devices has been provided, the disclosed subject matter is not so limited. Thus, it can be further understood that various modifications, alterations, addition, and/or deletions can be made without departing from the scope of the embodiments as described herein. Accordingly, similar non-limiting implementations can be used or modifications and additions can be made to the described embodiments for performing the same or equivalent function of the corresponding embodiments without deviating therefrom.

As used in this application, the terms “component,” “module,” “device” and “system” can refer to a computer-related entity, either hardware, a combination of hardware and software, software, or software in execution. As one example, a component or module can be, but is not limited to being, a process running on a processor, a processor or portion thereof, a hard disk drive, multiple storage drives (of optical and/or magnetic storage medium), an object, an executable, a thread of execution, a program, and/or a computer. By way of illustration, both an application running on a server and the server can be a component or module. One or more components or modules scan reside within a process and/or thread of execution, and a component or module can be localized on one computer or processor and/or distributed between two or more computers or processors.

As used herein, the term to “infer” or “inference” can refer generally to the process of reasoning about or inferring states of the system, and/or environment from a set of observations as captured via events, signals, and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the words “example” or “exemplary” is used herein to mean serving as an example, instance, or illustration. Any aspect or design described herein as “exemplary” is not necessarily to be construed as preferred or advantageous over other aspects or designs. Rather, use of the word, “exemplary,” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while an aspect may have been disclosed with respect to only one of several embodiments, such feature may be combined with one or more other features of the other embodiments as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. An apparatus, comprising:
electrical circuitry configured to receive an electrical signal from a first portion of a microelectromechanical systems (MEMS) sensor and generate an output signal associated with the first portion of the MEMS sensor;
a feedback component configured to generate a feedback signal based on the output signal for a second portion of the MEMS sensor; and
at least one filter component configured to filter the feedback signal for the second portion of the MEMS sensor.

2. The apparatus of claim 1, further comprising:
an integrated circuit (IC) comprising at least one of the electrical circuitry, the feedback component, or the at least one filter component.

3. The apparatus of claim 2, further comprising:
a MEMS sensor package comprising the MEMS sensor, wherein the IC is disposed in the MEMS sensor package.

4. The apparatus of claim 1, wherein the feedback signal comprises a bias voltage feedback signal for the second portion of the MEMS sensor.

5. The apparatus of claim 1, wherein the MEMS sensor comprises a MEMS acoustic sensor, wherein the first portion of the MEMS sensor comprises a diaphragm of the MEMS acoustic sensor, and wherein the second portion of the MEMS sensor comprises a backplate of the MEMS acoustic sensor.

6. The apparatus of claim 5, wherein the feedback signal is configured to at least one of reduce sensitivity of the MEMS acoustic sensor, increase an acoustic overload point (AOP) associated with the MEMS acoustic sensor, reduce a resonance peak associated with the MEMS acoustic sensor, reduce generated noise associated with the MEMS acoustic sensor, increase signal to noise ratio associated with the MEMS acoustic sensor, or modify frequency response of the MEMS acoustic sensor.

7. The apparatus of claim 1, wherein the feedback signal comprises an alternating current (AC) feedback signal configured to be combined with a direct current (DC) bias voltage applied to the second portion of the MEMS sensor.

8. The apparatus of claim 1, wherein the feedback component comprises an amplifier component configured to generate an inverted output signal based on the output signal and associated with the feedback signal.

9. The apparatus of claim 1, wherein the at least one filter component comprises at least one of a low pass filter component, a high pass filter component, a band pass filter component, or a band stop filter component.

10. The apparatus of claim 9, wherein the MEMS sensor comprises a MEMS microphone sensor and wherein the at least one filter component comprises the high pass filter component configured to have a cutoff frequency of less than or equal to about 19 kiloHertz (kHz).

11. The apparatus of claim 9, wherein the at least one filter component comprises the low pass filter component.

12. The apparatus of claim 11, wherein the MEMS sensor comprises a MEMS ultrasound sensor, wherein the low pass filter component is configured to have a corner frequency of greater than or equal to about 20 kiloHertz (kHz).

13. The apparatus of claim 11, wherein the low pass filter component is configured to have a corner frequency of about 100 Hertz (Hz).

14. The apparatus of claim 1, wherein the at least one filter component comprises at least one of a parallel arrangement, a series arrangement, or a series-parallel arrangement of a plurality of filters.

15. The apparatus of claim 1, wherein the at least one filter component comprises at least one of a first-order filter or a higher order filter.

16. The apparatus of claim 1, wherein the at least one filter component comprises at least one adjustable filter parameter.

17. The apparatus of claim 1, further comprising:
a filter control component configured to at least one of switch the at least one filter component between an on state and an off state or modify performance of the at least one filter component.

18. A method, comprising:
receiving an electrical signal from a first portion of a microelectromechanical systems (MEMS) sensor;
generating an output signal associated with the first portion of the MEMS sensor;
generating a feedback signal based on the output signal for a second portion of the MEMS sensor; and
filtering the feedback signal for transmission to the second portion of the MEMS sensor.

19. The method of claim 18, wherein the generating and the filtering the feedback signal comprises generating and filtering the feedback signal in an integrated circuit (IC) associated with the MEMS sensor.

20. The method of claim 18, wherein the generating the feedback signal comprises generating a bias voltage feedback signal for the second portion of the MEMS sensor.

21. The method of claim 18, wherein the generating the feedback signal comprises generating an alternating current (AC) feedback signal and further comprising combining the AC feedback signal with a direct current (DC) bias voltage applied to the second portion of the MEMS sensor.

22. The method of claim 18, wherein the filtering the feedback signal comprises adjusting at least one adjustable filter parameter to alter the feedback signal for the second portion of the MEMS sensor.

23. A system comprising:
a microelectromechanical systems (MEMS) sensor, wherein the MEMS sensor is configured to provide an electrical signal;
means for receiving the electrical signal from the MEMS sensor;
means for generating an output signal associated with a first portion of the MEMS sensor;
means for generating a feedback signal based on the output signal for a second portion of the MEMS sensor; and
means for filtering the feedback signal for transmission to the second portion of the MEMS sensor.

24. The system of claim 23, further comprising:
a MEMS sensor package comprising the MEMS sensor, the means for receiving, the means for generating the output signal, the means for generating the feedback signal, and the means for filtering.

25. The system of claim 23, wherein the MEMS sensor comprises a MEMS acoustic sensor, wherein the first portion of the MEMS sensor comprises a diaphragm of the MEMS acoustic sensor, wherein the second portion of the MEMS sensor comprises a backplate of the MEMS acoustic sensor, and wherein the feedback signal comprises a bias voltage feedback signal for the second portion of the MEMS sensor.
